(19) United States
(12) Patent Application Publication
(10) Pub. No.: US 2016/0232881 A1
(43) Pub. Date: Aug. 11, 2016

(54) String bender attachment for guitar vibrato

(71) Applicant: James Marion Alday, Honeoye Falls, NY (US)

(72) Inventor: James Marion Alday, Honeoye Falls, NY (US)

(21) Appl. No.: 14/544,696

(22) Filed: Feb. 5, 2015

(51) Int. Cl. G10D 3/02

(52) U.S. Cl. CPC G10D 3/02

(57) ABSTRACT

A string bending device includes a handle, handle bracket, and a lever, referred to as the puller, which replace the standard handle and handle bracket of a Bigsby® Vibrato. The handle bracket attaches to the string bar of the vibrato, about which the guitar strings are wrapped and terminated by attaching to pins projecting from the shaft of the string bar. The handle bracket is rigidly attached to the shaft and handle and lever are pivotally attached to handle bracket by separate parallel centers. The puller is pivoted through a limited arc, with adjustable stop screws at start and end of arc. The primary end of puller is actuated by contact with handle and secondary end of puller has aperture thru which one string passes, allowing compound leverage to stretch string to greater length when puller is pivoted about its axis. The pivot centers of both handle and lever are perpendicular to and offset from axis of shaft. An extension spring connects lever and handle bracket to apply torque to lever opposite that of string, reducing force required to stretch string. The handle is positioned generally parallel to top of guitar. Handle is generally parallel to strings, but lateral position is determined by start and stop positions of arc of lever travel. Handle is moved toward top of guitar to lower pitch of all strings and/or toward strings in direction generally parallel to top of guitar to raise pitch of one string. These movements can occur independently or simultaneously.

### BACKGROUND OF THE INVENTION

The present invention adds an intermediate part between the handle and string bar of a vibrato unit of the type most commonly referred to as a Bigsby® Vibrato. The string being bent or changed in pitch is attached to this part, rather than the string bar, as are the balance of the string set of the guitar. By manipulation of the handle of the Bigsby® unit in the usual manner toward or away from the body of the guitar, all strings, including the one attached to intermediate part are given a vibrato by slight rotation of the string bar and attached handle bracket. However, when handle is moved parallel to body toward strings, only the string attached to intermediate part is stretched, by a precise interval, increasing the pitch of the attached string by one half, or generally a full tone. The position of the handle is adjustable before its movement parallel to body, placing handle in the most convenient place for player, by an adjustment screw on the intermediate part. A second adjustment screw on the same part controls the final position of the part and thus the pitch of the raised note. The additional bending function is quickly and easily added to a standard Bigsby® Vibrato, and can easily be removed, and original parts replaced, restoring original appearance and function without any damage or disfigurement to either the vibrato or the guitar to which it is attached.

In the years following the invention and refinement of the pedal steel guitar during the 1950-1970 period, players of the electric guitar desired a way to simulate the “bend”, which is the gradual variation of one note's pitch from one defined note to another defined note, rather than an abrupt change to another note as would be achieved by simply fretting the string one or two frets higher on the guitar's neck. This gradual, continuous variation is what gives the pedal steel its distinctive sound, as differentiated from the earlier Hawaiian steel guitar, where several notes at once were all given an identical slurred change to another pitch. The ability to vary notes smoothly to another note one or two at a time, while leaving the rest of the chord's notes stationary, was a new sound, and quickly became a fixture of the musical style known a “Country Music”.

It was obvious that it would not be practical to add all the features of the pedal steel guitar to the standard electric guitars of the time, since many mechanical parts were required, and the forces involved in changing several notes at once would not only take more force than the player could readily spare, without interfering with playing, but the changes in total string tension on the neck of the guitar, would result in distortion of the neck itself, impairing tuning and string positions relative to the frets. It was found that one string could be fitted with a device to change its tension, and thus pitch, with an accurate stop at each of the two notes achieved, without undue loss of tuning accuracy of the remaining 5 strings, thus the string bender was born.

The first successful and well known unit was by Gene Parsons, and Clarence White, U.S. Pat. No. 3,512,443, of 1970. This required hollowing out a solid body guitar and adding several rods, springs, and levers internally, to allow raising the “B” string to “C#”, which has been the preferred string and change in pitch used till the present, in devices of this type. The change is achieved by lowering the neck of the guitar when change is desired, and one end of the shoulder strap of the guitar then pulls on a lever carrying the strap button. The weight of the guitar which normally carried by this end of the strap is balanced by a spring attached to the lever. Several more recent patents of the same basic type of mechanism are: U.S. Pat. No. 3,686,993-Fender-1972, U.S. Pat. No. 4,354,417-Glaser-1982, U.S. Pat. No. 5,481,954-Parsons-1996, and U.S. Pat. No. 5,567,897-McEwen-1996.

Other units have been created to bend a string, or in some cases, two strings, which don't require the guitar to be hollowed out, and mount on the surface, near the bridge, and are operated by wrist, palm or finger pressure. Such examples are: U.S. Pat. No. 3,479,917-Zitnik-1967, U.S. Pat. No. 5,140,884-Bowden-1990, U.S. Pat. No. 7,329,808-Davis-2008, and U.S. Pat. No. 7,696,420-Thompson-2010. All these are much simpler than the shoulder operated units, and are installed without severely altering the body of the guitar, which is non-reversible, and generally alters tone and response of guitar somewhat, as well as diminishing the value of a rare or vintage guitar.

Another actuation method is seen in U.S. Pat. No. 4,534,670-Borisoff-1985, which used a lever extending over the lower bout and reaches behind the body of the guitar to be actuated by hip or leg action of the player. This seems to work well for some, but requires removal of the lever to place guitar in its case.

While the refinement of the string bender has occurred, the vibrato units have also been refined, and today, a very large number of different models are available. All of these create a change in string pitch, but on all 6 strings at one time, and generally not to a specific alternate note, although some complex units exist, that will adjust the amount of change of each string pitch proportionately, so that the chord will remain true in its intervals, even as it is raised or lowered by the vibrato unit. Still, after 60 years, the Bigsby® Vibrato is still a favorite, and is still sold in large quantities, and is supplied as standard equipment on some models from almost all manufacturers. Its known limitations are its tendency to not return to pitch after large excursions in pitch, limited amount of total range of pitch variation, excessive friction in some models, and limited variation in string departure angle, which can cause either excessive or inadequate down pressure on the bridge of guitars so equipped. Still, its distinctive, classic appearance, surface mounting, availability in many models, and ability to produce a pleasant, modest amount of vibrato, make it desirable to the point that many players will have no other type of vibrato, and some, in fact, will not have any guitar without a Bigsby® Vibrato.

A number of guitars have been built having a bender of one type or other incorporated on a guitar carrying a Bigsby® Vibrato, but the string being bent is detached from the rotating shaft and connected only to the separate bending unit. Thus the vibrato occurs only on 5 strings and bending occurs on one string which no longer has vibrato capability. It would be desirable to produce a device for the Bigsby® Vibrato which would allow full vibrato on all 6 strings but allow one of these strings to be tensioned to a different pitch while retaining any vibrato being imparted to the other 5 strings. It also would be desirable to produce both the vibrato and bend with one handle which is convenient and readily accessible to the player's hand without major disturbance to the hand as it picks notes or chords. It also would be desirable to allow the handle to be moved aside for occasions when neither bending nor vibrato is desired.

It would also be desirable to add bending capability without altering or defacing the guitar or the Bigsby® Vibrato in any way, allowing restoration to pre-bender status merely by removing b-bender components and replacing original handle.

### SUMMARY OF THE INVENTION

One object of the present invention is to add the capability of raising the pitch of one string of a guitar to a note either one half tone or one full tone above its normal tuned pitch, and adjusting the raised pitch to precisely blend with one or more of the other, unmodified 5 pitches, to create a correct chord, or interval. This requires precision and repeatability of the motion imposed on the affected string, and the capability of adjusting the exact amount of tension increase, and subsequent pitch rise of the affected string.

Therefore another object of the present invention is to create a precise means of stopping the string travel at both its un-actuated or normal state, and at its actuated or raised state.

Another object of the present invention is to allow the pitch of one string, to be raised without compromising the pitch of any of the other 5 strings.

Another object of the present invention is to create the precise variation in pitch of one string, utilizing only the same handle which is used to produce the normal vibrato effect of the Bigsby® Vibrato unit. The handle thus is used to produce a small, non-precise variation in pitch of all 6 strings (vibrato), which varies during the operator's operation of the handle, as well as a precise, larger variation, of one string, which is superimposed upon the vibrato pitch variation of all 6 strings. It should be noted that in normal vibrato mode, the pitch variation of each of the 6 strings of the guitar will be slightly different, as each string has a different diameter, tension, rate of tension change with length variation, rate of pitch variation with length variation, and in fact operates at slightly different radius about the rotating shaft as it is rocked by the handle and handle bracket. This last effect is due to the stretching characteristics of the string being controlled by the core and not the winding of the wound strings, the core of each wound string operating at a slightly different radius about the shaft.

Another object of the present invention is to utilize handle motion essentially parallel to the top of the guitar to produce the large, precise pitch rise of one string, while utilizing handle motion toward or away from the top of the guitar, to produce the smaller, non-precise pitch change of all 6 strings simultaneously.

Another object of the present invention is to allow easy removal of original handle and handle bracket of the Bigsby® Vibrato unit, and replace it with the assembly previously described, by removing one screw, sliding the original handle bracket off the shaft, and replacing with the new aforementioned assembly, and installing and tightening one screw.

Another object of the present invention is to retain the actuation forces, original vertical positioning, and leverage of the original Bigsby® Vibrato unit, when utilized as a vibrato.

Another object of the present invention is to provide a low operating force at the handle in raising the pitch of one string a half or full tone by adding an assist spring to balance a variable portion of the normal string tension when in the un-actuated position. Furthermore, said spring should be of spring rate low enough so that when string is raised a half or full tone, the force of the spring decreases a minimal amount. Thus when string force rises as it is stretched tighter to higher pitch, the decrease in spring length (extension spring), or increase in length (compression spring), causes as small a change in spring forces as is practicable in the space available for the spring. Also, the basic assist force of the spring can be adjusted by adjusting the spring to two or more initial extension lengths, giving more or less assist.

Another object of the present invention is to reduce actuation forces required by incorporating a second pivot axis on the handle bracket which provides a location to mount the puller and, by utilizing the handle and its separate pivot axis, to give a compound leverage to the player.

Another object of the present invention is to allow variation in the mechanical advantage of the lateral handle motion, by varying the position of a friction-reducing bearing between the two moving parts of the new assembly, thus changing the radius of contact point of each moving part relative to its pivot center. This in turn varies force required on handle to actuate string bending motion, as well as handle travel required.

Another object of the present invention is to add a contour to the handle of the new embodiment allowing easier grasping by one finger, which would in some cases be used to provide the lateral motion parallel to guitar top in raising one string to its half or full tone raised pitch. This shape would prevent slipping of the finger along the handle, altering mechanical advantage, and changing operating force required. The contour provides both constant operating position and constant sensitivity of the pitch variation.

Another object of the present invention is to provide a swing-away motion to the handle, in direction opposite to actuation direction, to mimic the same function of the original handle, This allows the handle to be moved out of the way for actions such as strumming the guitar, in which case the hand or pick could impact the handle, if left in position for bending or vibrato.

Another object of the present invention is to provide for the adjustment of the start or un-actuated position of the handle's lateral position. This affects the reach necessary for the player to grasp the handle with one or more fingers, and is desirable to accommodate a player's hand size, and preferences.

Another object of the present invention is providing easy adjustment of both aforementioned start position of handle, as well as actuated position, which controls final raised pitch, without the necessity of tools.

Another object of the present invention is provision for easy adjustment of friction controlling lateral motion of handle without necessity for access underneath handle bracket, as is case with present Bigsby® handle. This friction is necessary to prevent handle from falling away from accessible position when it is desired to be instantly available for use, but must be low enough to not hinder lateral motion to raise a string a half or full tone.

Another object of the present invention is to provide a common assembly to adapt the string bending function to multiple models of Bigsby® Vibrato. Domestic models have for many years utilized a ⅜ inch diameter shaft about which the strings wrap, and to which the handle bracket is attached. Imported models use a 10 mm diameter shaft, which is nominally 0.019 in. larger in diameter. By using a non-circular mounting hole in the handle bracket of the new assembly, a single assembly can be made, which will attach solidly and simply, to either diameter shaft, and will be firmly retained in position by one setscrew.

Another object of the present invention is to retain the original feel and sensitivity of the Bigsby® Vibrato unit after adding the string bending capability to the unit. For this reason the string attached to the string bending assembly must pass as close to the mounting shaft as is practicable without rubbing upon the shaft. This ensures that the string motion in vibrato mode will be essentially as before the modification since the effective operating radius for that string will only be a tiny bit more than it would be if touching the shaft.

### BRIEF DESCRIPTION OF THE SEVERAL VIEWS OF THE DRAWINGS

The features and operation of the string bender attachment will become apparent, when all the component parts are defined, and their relations to each other and the existing Bigsby® vibrato are explained. The item numbers are consistent in referring to the same part in all drawings.

FIG. 1 is a plan view of the string bender attachment, mounted on a guitar, showing positions of the handle and puller both when released and when actuated to raise the pitch of attached string. Also indicated is an alternate retracted position of the handle where it will be conveniently out of reach of player's right hand when neither vibrato nor bending is desired.

FIG. 2 is an exploded view of the string bender attachment, along with a Bigsby® Vibrato (minus its original handle assembly), and typical bridge and pickup assembly.

FIG. 3 is an assembled view of the string bender attachment mounted on a Bigsby® Vibrato, along with bridge and pickup assembly.

FIG. 4 is a side view of the handle bracket, showing configuration of aperture designed to solidly attach handle bracket to either a ⅜ in. diameter shaft or 10 mm diameter shaft, as would be encountered on domestic or imported versions of Bigsby® vibratos, respectively.

FIG. 5 is a bottom view of the vibrato unit, when normal tuning is desired, and handle is not displaced laterally toward strings, parallel to top of guitar. This also would apply if vibrato alone were being used, and handle were being moved perpendicular to top of guitar, varying pitch of all strings.

FIG. 6 is the bottom view as in FIG. 5, but with the handle moved toward strings, parallel to top of guitar, and puller is pivoted, providing increased string length to one string and consequently raising its pitch. The vibrato on all 6 strings may be employed at same time, by handle being moved perpendicular to top of guitar.

FIG. 7 is an exploded view of the handle bracket and puller, minus the handle and associated hardware, to indicate parts and surfaces contacted during operation.

### DETAILED DESCRIPTION OF THE PREFERRED EMBODIMENT

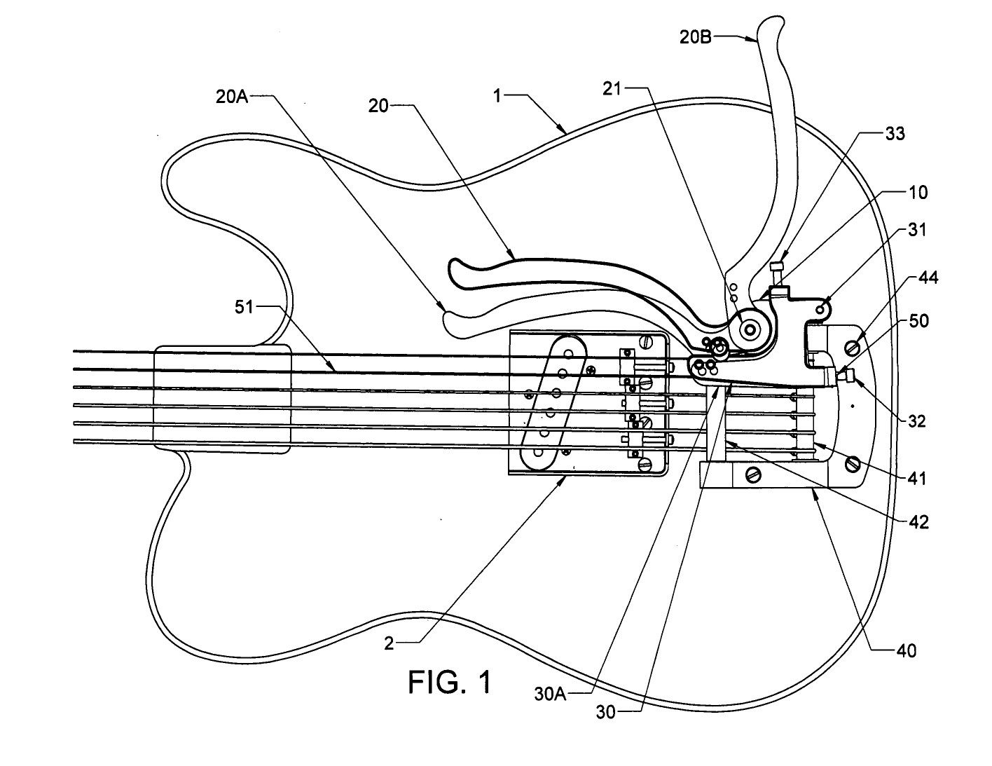

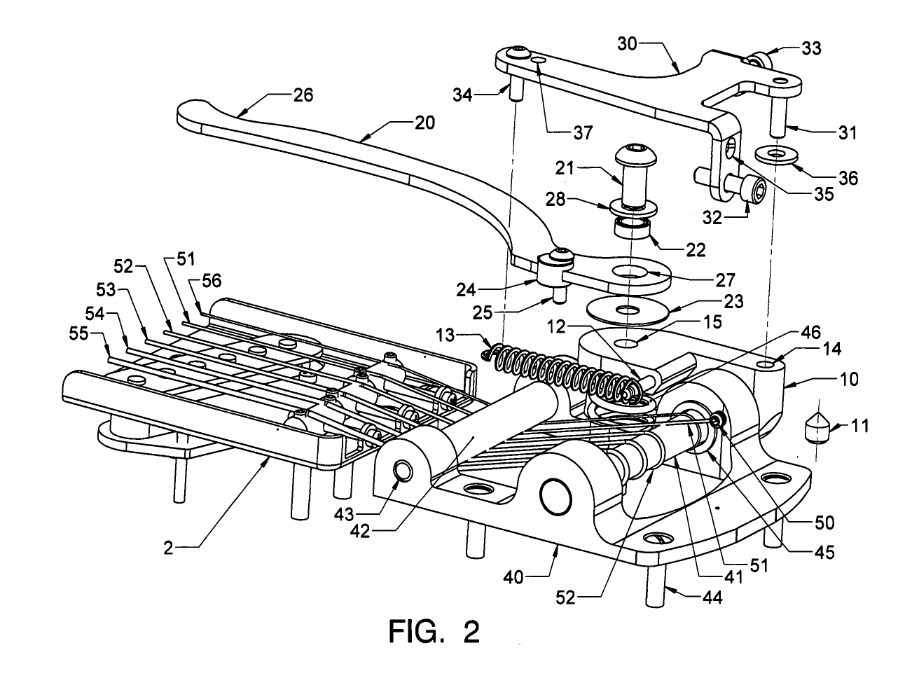

FIG. 1 shows a plan view of a typical guitar body 1 with a bridge-pickup assembly 2 mounted on its top surface and a vibrato unit carrying b-bender attached to the same top surface with screws 44. The vibrato unit is of a type commonly referred to as a Bigsby® Vibrato, and is characterized as having a frame 40 which supports a string bar 41 pivotally mounted in frame 40, about which the string set of the guitar is wrapped and retained by pins mounted to shaft of string bar. Frame 40 also supports tension roller 42 which is used on some models of the Bigsby® Vibrato to lower the path of the strings as they exit the vibrato unit to provide a greater angular wrap and resultant down force on top of string saddles on bridge-pickup assembly 2. A handle bracket 10 is rigidly attached to string bar 41 and carries handle 20 which is pivotally attached to handle bracket 10 by screw 21, allowing handle 20 to approach strings as shown by CCW alternate position 20A, or swing completely away from strings as shown by CW alternate position 20B. The typical playing position of handle 20 is essentially parallel to strings typified by string 51, although its static position is determined by setting of stop screw 32, and CCW actuated position 20A is determined by setting of tuning screw 33. These two positions of handle 20 are due to the contact of bearing 24 (FIG. 2) against side of puller 30 which mounts both stop screw 32 and tuning screw 33. Puller 30 is shown in its CCW actuated position 30A, which corresponds to handle position 20A. There is no position of puller 30 corresponding to handle posit 20B, since its rotation in CW direction is limited by stop screw 32. Before, after, or during CCW rotation of handle 20 in plane essentially parallel to top of guitar body 1, handle 20 can be moved toward or away from body 1 as is the customary actuation of the handle of a Bigsby® Vibrato to create its customary lowering or raising of pitch respectively of all 6 strings. This action will cause handle bracket 10 and attached string bar 41 to rotate in frame 40 and decrease or increase respective wrap of strings about string bar 41. Puller 30 pivots upon rigidly attached pin 31 which rotates in hole 14 (FIG. 2) of handle bracket 10. String 51 is terminated by string ball 50 contacting puller 30 and thus when string bar 41 rotates in frame 40, string 51 is loosened or tightened since string 51 passes string bar 41 either touching surface of string bar 41 or slightly above it, creating variation in its length the same as or slightly greater than balance of string set.

FIG. 2 shows all the component parts of the string bending attachment and their relationship to each other and the existing. Bigsby® Vibrato (minus its original handle assembly) in exploded view as well as bridge-pickup assembly 2.

Handle bracket 10 as attached to shaft 41 and is firmly retained by setscrew 11 using tapped hole in bottom of handle bracket 10 and bottoming in existing recess in shaft 41. This locates handle bracket 10 both axially and rotationally on shaft 41. Pin 12 is rigidly retained in handle bracket 10 and serves as mounting point for end of extension spring 13. The other end of spring 13 is attached to pin 34 in end of puller 30. Spring 13 is selected to counteract a portion of the tension of the string 51 and reduce force necessary on handle at position 26 to move puller 30 to point where tuning screw 33 contacts handle bracket 10. Spring 13 and string 51 each invoke a torque load on puller 30 about its pin 31, but in opposite directions. Moving pin 34 to hole 37 in puller 30 will reduce spring force and provide less assist to player in actuating handle 20 at position 26. Washer 36 serves to separate puller 30 from handle bracket 10 to keep puller in same plane as handle 20 which is separated from handle bracket 10 by friction washer 23. Handle 20 is held against friction washer 23 by screw 21 and washer 28 and located radially by bearing 22. Screw 21 is retained in handle bracket 10 by threads in aperture 15 and adjusted to provide proper level of friction to prevent handle 20 from falling out of reach of player when guitar is in normal playing position.

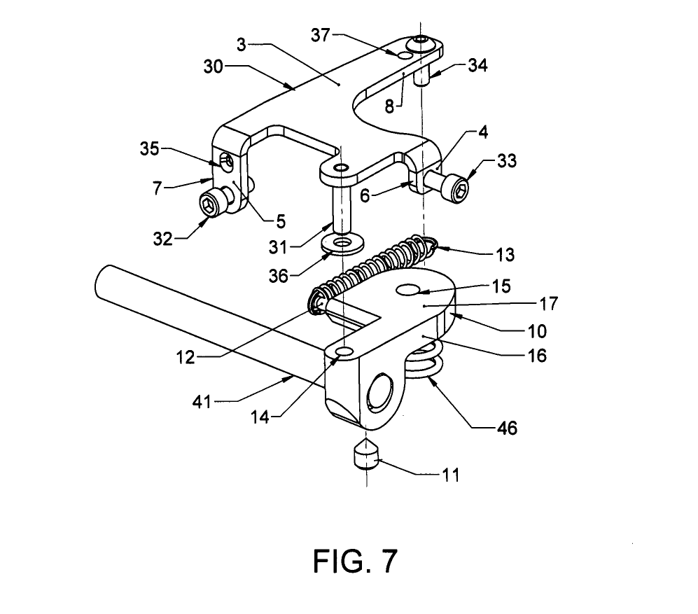

The cumulative tension loads of strings 51-56 produce a torque on string bar 41 and attached handle bracket 10 which is balanced by spring 46 producing an equal torque in opposite direction. Variations in spring rate and free length of spring 46 as well as variations in string diameters and tuning tensions of strings 51 thru 56 will cause variations in static rotational position of string bar 41 and subsequent static rotational position of handle bracket. This will cause the static position of surface 17 (FIG. 7) of handle bracket 10 to deviate from parallel to top of guitar and cause handle 20 to have the same deviation. This can be corrected to some degree by selection of spring 46 from several different lengths and spring rates available from numerous suppliers.

Tension roller 42 is retained in frame 40 by pin 43 which serves as a shaft allowing slight rotation of roller 42 as handle 20 is moved toward or away from top of guitar to produce vibrato. String 51 when moved by puller 30 will move a greater amount than any of the 6 strings normally see in vibrato application, and will normally slip on surface of roller rather than cause rotation since roller is retained by 5 strings exerting much greater torque. For this reason, a slight amount of lubricant on string at contacting area will prevent excessive wear or noise.

Puller 30 is attached to handle bracket 10 by rigidly attached pin 31 which is inserted into close fitting hole 14 in handle bracket 10. Puller 30 is rotationally stopped on handle bracket 10 by tuning screw 33 which contacts handle bracket 10 when actuated and serves to limit rotation of puller 30 in CCW direction when viewed from top as in FIG. 1. Puller 30 is rotationally stopped in CW direction by stop screw 32 which contacts string bar 41 when puller 30 is not actuated and no force is being applied to handle 20. Since string bar 41 is rigidly attached to handle base 10 the operational travel or stroke of puller 30 is determined by the gap between screw 33 and handle bracket 10 when no actuation of handle 20 or puller 30 is occurring. String ball 50 is attached to end of string 51 and is retained in thru hole 35.

Handle 20 is attached to handle bracket 10 by screw 21 passing thru bearing 22 which is inserted in hole 27 in end of handle 20. Friction washer 23 serves to separate handle 20 and handle bracket 10 and allows adjustment of rotational drag on handle 20 to prevent handle falling away from player's hand when not being touched but allowing rotating to position 20B. Screw 21 is tightened in threaded hole 15 in handle bracket 10 to set drag from friction washer 23.

Contact bearing 24 is attached to handle 20 by screw 25 allowing a low friction contact between handle 20 and side surface of puller 30 when actuating puller to raise string pitch. There may be 2 or more holes in handle 20 allowing a variation in positioning slide bearing 24 and consequently the overall mechanical advantage of handle 20 to puller 30. Item 24 can take several forms and can be as simple as a nylon tie-wrap retained in one of the holes in handle 20 and wrapped around side to provide a low friction surface to bear on side of puller 30. It is understood that optimum performance would require a slight lubrication of pin 31 as it fits in hole 14 as well as on both surfaces of washer 36.

Typically handle 20 is kept in contact with puller 30 at contact bearing 24 when guitar is in playing position by drag from friction washer 23 after careful adjustment of screw 21.

The frame 40 of the vibrato is attached to top of guitar by screws 44 and also retains bearings 45 which allow shaft 41 to rotate freely along with the rigidly attached handle bracket 10.

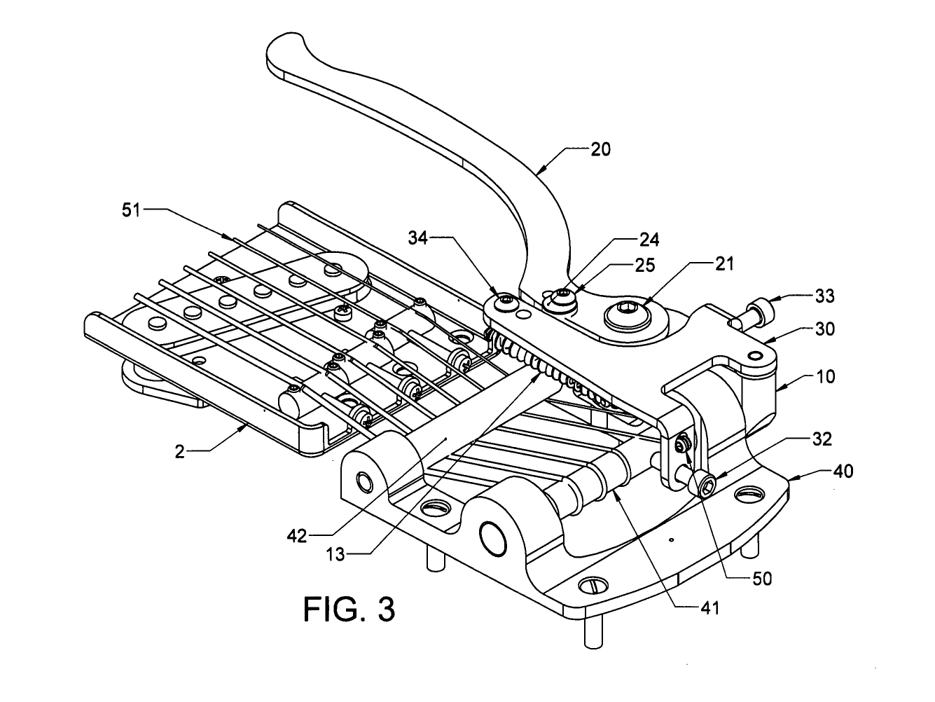

FIG. 3 shows items of FIG. 2 assembled with string 51 and string ball 50 located in puller 30 and stop screw resting upon string bar 41 as would appear with guitar tuned to pitch on all strings and no bending activated.

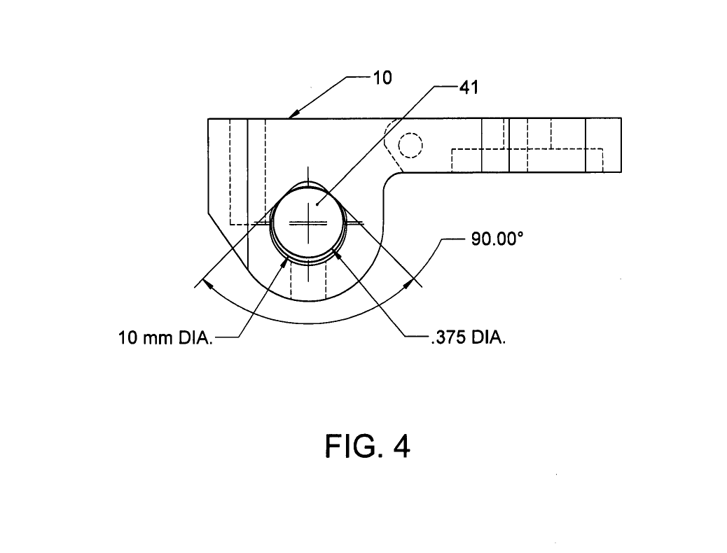

FIG. 4 shows the configuration of the aperture in handle bracket 10 to allow fitting to either domestic 0.375 in. diameter string bar 41 or imported 10 mm diameter string bar 41. The configuration is a modified V-block with the setscrew 11 forcing shaft 41 securely into V form to provide positive positioning. The tiny difference in center locations of the different shaft diameters relative to handle bracket 10 is of no functional or visual consequence.

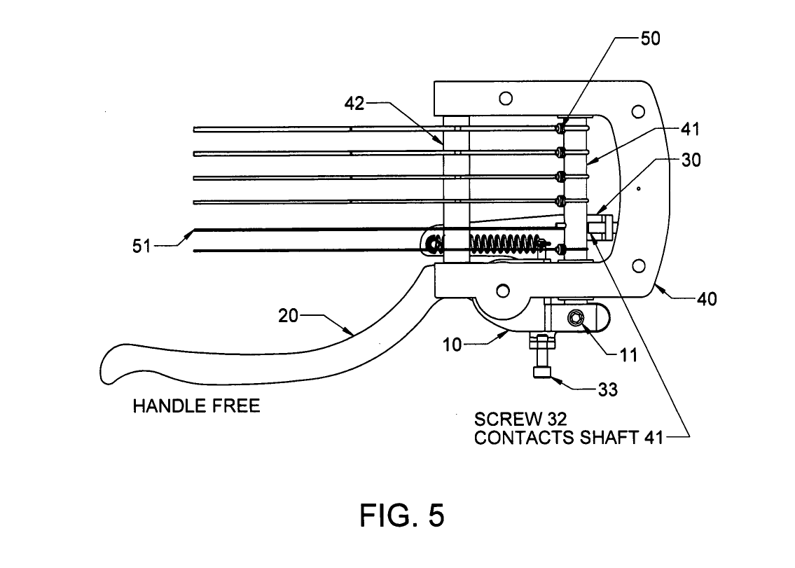

FIG. 5 is a bottom view of frame 40 with string bar 41, tension roller 42, handle bracket 10, handle 20, and puller 30 installed, and all strings 51-56 installed. String 51 passes on nearside of tension roller 42, far side of string bar 41 and passes thru puller 30 where retained by string ball 51(behind screw 32 this view). One of the pins for retaining strings on string bar 41 is shown as string 51 is not anchored to string bar. The other 5 strings are attached to remaining 5 pins by means of string ball 51 on end of each string. In this view the strings pass to right on nearside of string bar 41 then proceed around string bar to proceed to left on far side of string bar and pass on nearside of tension roller 42. All strings would proceed to bridge-pickup assembly 2 (not shown) from tension roller 42. The handle is not moved from rest position, and stop screw 32 contacts string bar 41. Tuning screw 33 is not touching handle bracket 10 and resultant gap represents motion necessary for pitch of string 51 to be changed from B note to C# note on open string (at typical tuning). It should be noted that the initial setting of stop screw 32 varies the basic length of string 51, and changes to this setting will require retuning of the string at opposite end of string 51 at tuner on head of guitar. It should also be noted that the setting of stop screw 32 serves to set position of end of handle 20, relative to strings, and in fact is the primary adjustment required after installation of the b-bender attachment to place handle in convenient position relative to strings.

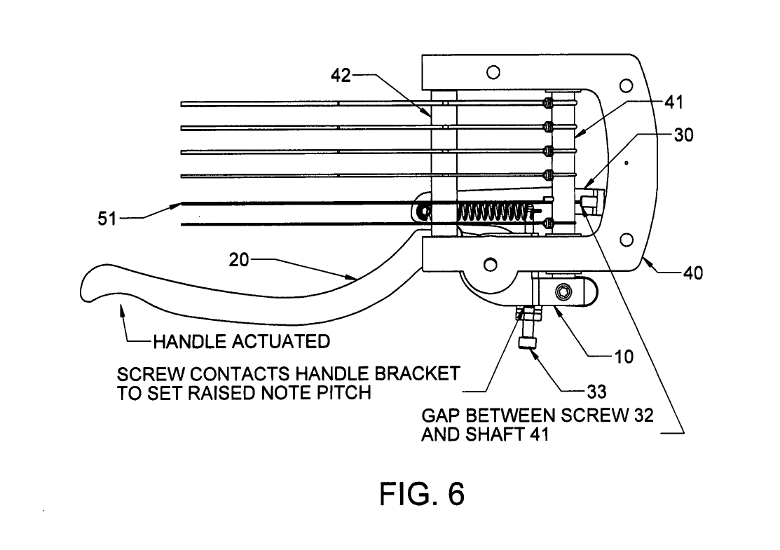

FIG. 6 is the bottom view of FIG. 5 repeated, but with handle moved toward strings, pivoting about its screw 21(far side) and actuating puller 30 thru contact bearing 24. The pitch of string 51 has now been raised from B to C# (at typical tuning) and stop screw 32 has been lifted from contact with string bar 41. Tuning screw 33 now contacts handle bracket 10 and any fine tuning of raised string pitch is accomplished by slight rotation of tuning screw 33. The sequence of tuning the guitar's string 51 is: adjust stop screw 32 to place handle 20 where desired, relative to strings, then tune string 51 at headstock of guitar with normal tuner, then actuate handle 20, and adjust tuning screw 33 to get pitch of raised note as desired.

FIG. 7 shows handle bracket 10 with surface 16 perpendicular to axis of string bar 41 and perpendicular to aperture shown in FIG. 4. Surface 17 is perpendicular to surface 16 and is penetrated by 2 apertures, 14 and 15. Spring 13 attaches to pin 12 which lies parallel to string bar 41. Aperture 15 is concentric with end of spring 46.

Puller 30 has primary surface 3 and has two surfaces perpendicular to surface 3, the first being surface 5 on formed tab 7 and the second being surface 4 on formed tab 6. Surface 4 is perpendicular to surface 5. Tuning screw 33 is threaded thru tab 6, perpendicular to surface 4. Stop screw 32 is threaded thru tab 7, perpendicular to surface 5. Rigidly attached pivot pin is perpendicular to surface 3. Formed tab 7 also carries aperture 35 which is parallel to and offset from stop screw 32.

In use, contact bearing 24 (FIG. 2) mounted on handle 20 (FIG. 2) contacts surface 8 on puller 30 causing it to pivot about pin 31 in hole 14 until tuning screw 33 contacts surface 16 on handle bracket 10. At this same time stop screw 32 has been raised from contact with string bar 41. Spring 13 assists in this same pivoting of puller 30, decreasing the required force on handle 20.

What is claimed is:

1. A string bending attachment for a Bigsby or Bigsby type vibrato unit for a guitar, which allows one string of the guitar's string set to be raised an exact Interval, generally a half tone or full tone, without affecting the pitch of the other strings of the string set, and retaining the original vibrato capability of the entire string set, comprised of:
a. A handle bracket which attaches to a shaft about which the strings of the guitar are wrapped at least a portion of its circumference and terminated, said shaft being mounted in a frame which is attached to top surface of guitar and supported in bearings to allow rotation of shaft to raise or lower pitch of all strings. This handle bracket is attached to shaft, after removing the handle bracket normally supplied by manufacturer, and securing at same position on shaft by identical setscrew means. This handle bracket is attached to or resting upon a spring in same manner as original handle bracket at end substantially opposite said shaft. Said handle bracket has 2 parallel axes, both perpendicular to hole which serves to attach said bracket to aforementioned shaft. One axis comprises a recess for said spring on lower surface, and threaded hole on upper surface, which serves as mounting means for handle attachment. The second axis serves as mounting means for another part called the puller, which is rotationally actuated by the handle about this second axis, and to which one string of the guitar's set of strings is attached. Both of these axis are nominally perpendicular to top or face of guitar, when handle bracket is properly attached to shaft. Variations in string gauges, tuned pitch, and spring rate all affect final tuned position of handle bracket, and thus handle mounting surface can vary from its nominal parallel position, relative to top or face of guitar, by several degrees
b. A handle, which replaces the handle originally supplied by manufacturer of Bigsby vibrato unit, and mounts in substantially the same manner to handle bracket. This handle carries a detachable cam surface, at some radius from its axis on aforementioned handle bracket, which bears against the puller, at some radius from the second axis on the handle bracket which mounts the puller, thus providing a mechanical compound lever.
c. A puller, which pivots about aforementioned second axis on handle bracket, and is acted upon by cam surface on handle at one effective radius from said second axis, and string tension at second effective radius from said second axis, and a coil extension or compression spring at a third effective radius from said second axis. Puller is stopped in CW rotation, when looking at top or face of guitar by adjustment screw in bent tab perpendicular to main body of puller and resting upon shaft about which 5 strings are wrapped. Puller is stopped in CCW rotation when looking at top or face of guitar by adjustment screw in second bent tab which is perpendicular to both body of puller and first bent tab. This screw contacts surface of handle bracket which is perpendicular to top or face of guitar, when handle is moved laterally to create a raised pitch on desired string. The use of adjustment screws at both start and end of rotation of puller allows the start and end position of both puller, and the handle which is actuating it to be adjusted. This allows player to set handle distance from strings according to hand size, finger length and playing style. This adjustment of handle position is in a plane substantially parallel to top or face of guitar as previously defined.
d. A coil spring, either compression or extension, connecting puller and handle base in such a way as to create a torque tending to rotate puller in CCW direction as seen from top of guitar, counteracting a portion of the string pull which tends to rotate puller CW, when viewed from top of guitar, thus reducing force required to be transferred to puller by handle, and reducing player's required force on handle

2. The string bending attachment as defined in claim 1 where position of cam surface on handle can be varied to change effective radius from axis of handle so that effective leverage of handle upon puller is variable.

3. The string bending attachment as defined in claim 1 where the vibrato effect on all 6 strings of guitar is created by player moving tip of handle toward or away from top or face of guitar body and string bending or change of pitch of one string is accomplished by player moving tip of handle in a motion substantially parallel to top or face of guitar.

4. A handle assembly for a guitar vibrato utilizing a string bar carrying pins for retention of string ends about which strings are wrapped and caused to vary in pitch by rotation of said string bar comprising:
a handle bracket which attaches to string bar by means of aperture accepting end of string bar and being rigidly retained by setscrew;
a handle pivotally attached to handle bracket;
a puller pivotally attached to handle bracket;
an extension coil spring connected at one end to handle bracket and connected at opposite end to puller.

5. The handle bracket as recited in claim 4 having an aperture capable of accepting and rigidly retaining string bars of different diameters, and having features for pivotally retaining both handle and puller on same surface, and having feature for retaining end of extension spring and having feature for retaining end of compression spring.

6. The puller recited in claim 4 having a fixed pivot pin engaging handle bracket; and having adjustable stop screws to precisely limit pivoting in both directions; and
having feature to retain end of guitar string: and
having feature to retain end of extension spring.

7. The handle as recited in claim 4 having integral or attached contacting feature to contact puller in a manner and position as to cause puller to rotate upon its pivot pin so as to stretch attached string.
